(19) United States
(12) Patent Application Publication
(10) Pub. No.: US 2017/0093966 A1
(43) Pub. Date: Mar. 30, 2017

(54) MANAGING A SHARED POOL OF CONFIGURABLE COMPUTING RESOURCES HAVING AN ARRANGEMENT OF A SET OF DYNAMICALLY-ASSIGNED RESOURCES

(71) Applicant: International Business Machines Corporation, Armonk, NY (US)

(72) Inventors: Joseph W. Cropper, Rochester, MN (US); Robert K. Foster, Austin, TX (US); Stephanie L. Jensen, Austin, TX (US); Jeffrey W. Tenner, Rochester, MN (US); Pingping Zhang, Qingdao (CN)

(21) Appl. No.: 14/867,729

(22) Filed: Sep. 28, 2015

(51) Int. Cl. H04L 29/08

(52) U.S. Cl. CPC H04L 67/1025

(57) ABSTRACT

Disclosed aspects manage a shared pool of configurable computing resources. A request to place an asset which has a set of threshold resource values is detected. A first arrangement for a set of dynamically-assigned resources is determined. The first arrangement includes a first assignment of at least a portion of the set of dynamically-assigned resources to a first host. The first host uses the first assignment to meet the set of threshold resource values. Accordingly, the first arrangement is established.

### BACKGROUND

This disclosure relates generally to computer systems and, more particularly, relates to managing a shared pool of configurable computing resources having an arrangement of a set of dynamically-assigned resources. The amount of data that needs to be managed by enterprises is increasing. Management of a shared pool of configurable computing resources may be desired to be performed as efficiently as possible. As data needing to be managed increases, the need for management efficiency may increase.

### SUMMARY

Aspects of the disclosure are used to manage a shared pool of configurable computing resources which uses a set of dynamically-assigned resources with respect to capacity-on-demand technology. A request to place an asset which has a set of threshold resource values is detected. A first arrangement for a set of dynamically-assigned resources is determined. The first arrangement includes a first assignment of at least a portion of the set of dynamically-assigned resources to a first host. The first host uses the first assignment to meet the set of threshold resource values. Accordingly, the first arrangement is established. Disclosed aspects may include automatic (re)assignment of dynamically-assigned resources in a cloud environment based on asset requirements. An arrangement of dynamically-assigned resources which facilitates efficient operations may occur without manual intervention.

In embodiments, in response to detecting the request to place the asset, an initial arrangement for the set of dynamically-assigned resources is identified. The initial arrangement may include an initial assignment of the set of dynamically-assigned resources to a set of hosts. Using the initial assignment, the set of threshold resource values exceeds a set of initial resource values of the set of hosts. In embodiments, the request to place the asset is processed using the first arrangement. In various embodiments, processing the request to place the asset using the first arrangement can include at least one of deploying a virtual machine, rebuilding a virtual machine, resizing a virtual machine, or migrating a virtual machine (e.g., a cold migration). Altogether, performance or efficiency benefits when managing a shared pool of configurable computing resources may occur.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a cloud computing node according to embodiments.

FIG. 2 depicts a cloud computing environment according to embodiments.

FIG. 3 depicts abstraction model layers according to embodiments.

FIG. 4 is a flowchart illustrating a method for managing a shared pool of configurable computing resources according to embodiments.

FIG. 5 is a flowchart illustrating a method for managing a shared pool of configurable computing resources according to embodiments.

FIG. 6 is a flowchart illustrating a method for managing a shared pool of configurable computing resources according to embodiments.

FIG. 7 is a flowchart illustrating a method for managing a shared pool of configurable computing resources according to embodiments.

FIG. 8 shows an example system having a shared pool of configurable computing resources which uses a set of dynamically-assigned resources with respect to capacity-on-demand technology according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure relate to capacity-on-demand technology which allows compute servers to have compute resources (e.g., processors, memory) dynamically assigned/activated (e.g., to make efficient use of licenses). Disclosed aspects may include automatic (re)assignment of dynamically-assigned resources (e.g., mobile capacity-on-demand resources) in a cloud environment based on asset requirements (e.g., virtual machine requirements). An arrangement of dynamically-assigned resources which facilitates efficient operations may occur without manual intervention. Capacity-on-demand resources can be expensive for customers and efficient usage of such resources can provide performance benefits such as high availability, for example.

Aspects of the disclosure include a method, system, and computer program product for managing a shared pool of configurable computing resources. A request to place an asset which has a set of threshold resource values is detected. A first arrangement for a set of dynamically-assigned resources is determined. The first arrangement includes a first assignment of at least a portion of the set of dynamically-assigned resources to a first host. The first host uses the first assignment to meet the set of threshold resource values. Accordingly, the first arrangement is established.

In embodiments, in response to detecting the request to place the asset, an initial arrangement for the set of dynamically-assigned resources is identified. The initial arrangement may include an initial assignment of the set of dynamically-assigned resources to a set of hosts. Using the initial assignment, the set of threshold resource values exceeds a set of initial resource values of the set of hosts. As such, the first arrangement may be determined in response to identifying the initial arrangement. In various embodiments, establishing the first arrangement includes transitioning a first dynamically-assigned resource from the set of hosts to the first host. In a first status, the set of hosts can include an initial host which initially has both the first dynamically-assigned resource and an indication of the asset. In a second status, the set of hosts may include a second host which initially has the first dynamically-assigned resource without an indication of the asset. In a third status, the first host can initially have an indication of the asset without the first dynamically-assigned resource.

In embodiments, the request to place the asset is processed using the first arrangement. In various embodiments, processing the request to place the asset using the first arrangement can include at least one of deploying a virtual machine, rebuilding a virtual machine, resizing a virtual machine, or migrating a virtual machine (e.g., a cold migration). Altogether, performance or efficiency benefits when managing a shared pool of configurable computing resources may occur (e.g., speed, flexibility, responsiveness, availability, resource usage, productivity). Aspects may save resources such as bandwidth, processing, or memory.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

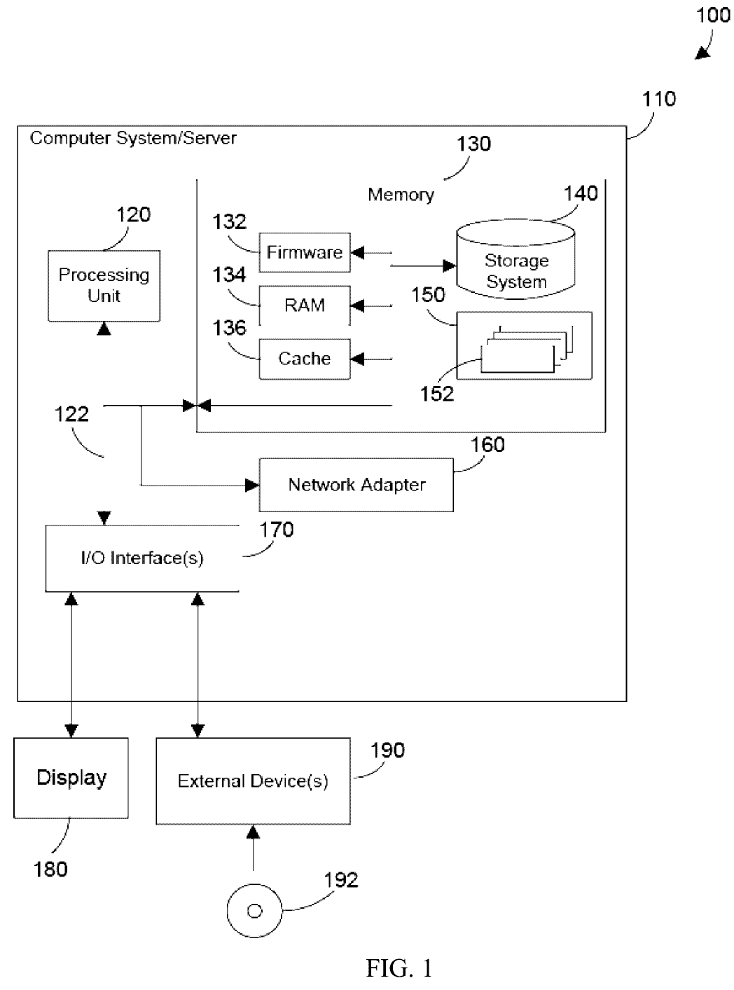

Referring now to FIG. 1, a block diagram of an example of a cloud computing node is shown. Cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth hereinabove.

In cloud computing node 100 there is a computer system/server 110, which is operational with numerous other general purpose or special purpose computing system environments or configurations. Examples of well-known computing systems, environments, and/or configurations that may be suitable for use with computer system/server 110 include, but are not limited to, personal computer systems, server computer systems, tablet computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 110 may be described in the general context of computer system executable instructions, such as program modules, being executed by a computer system. Generally, program modules may include routines, programs, objects, components, logic, data structures, and so on that perform particular tasks or implement particular abstract data types. Computer system/server 110 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 110 in cloud computing node 100 is shown in the form of a general-purpose computing device. The components of computer system/server 110 may include, but are not limited to, one or more processors or processing units 120, a system memory 130, and a bus 122 that couples various system components including system memory 130 to processing unit 120.

Bus 122 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 110 typically includes a variety of computer system readable media. Such media may be any available media that is accessible by computer system/server 110, and it includes both volatile and non-volatile media, removable and non-removable media. An example of removable media is shown in FIG. 1 to include a Digital Video Disc (DVD) 192.

System memory 130 can include computer system readable media in the form of volatile or non-volatile memory, such as firmware 132. Firmware 132 provides an interface to the hardware of computer system/server 110. System memory 130 can also include computer system readable media in the form of volatile memory, such as random access memory (RAM) 134 and/or cache memory 136. Computer system/server 110 may further include other removable/non-removable, volatile/non-volatile computer system storage media. By way of example only, storage system 140 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 122 by one or more data media interfaces. As will be further depicted and described below, memory 130 may include at least one program product having a set (e.g., at least one) of program modules that are configured to carry out the functions described in more detail below.

Program/utility 150, having a set (at least one) of program modules 152, may be stored in memory 130 by way of example, and not limitation, as well as an operating system, one or more application programs, other program modules, and program data. Each of the operating system, one or more application programs, other program modules, and program data or some combination thereof, may include an implementation of a networking environment. Program modules 152 generally carry out the functions and/or methodologies of embodiments of the invention as described herein.

Computer system/server 110 may also communicate with one or more external devices 190 such as a keyboard, a pointing device, a display 180, a disk drive, etc.; one or more devices that enable a user to interact with computer system/server 110; and/or any devices (e.g., network card, modem, etc.) that enable computer system/server 110 to communicate with one or more other computing devices. Such communication can occur via Input/Output (I/O) interfaces 170. Still yet, computer system/server 110 can communicate with one or more networks such as a local area network (LAN), a general wide area network (WAN), and/or a public network (e.g., the Internet) via network adapter 160. As depicted, network adapter 160 communicates with the other components of computer system/server 110 via bus 122. It should be understood that although not shown, other hardware and/or software components could be used in conjunction with computer system/server 110. Examples, include, but are not limited to: microcode, device drivers, redundant processing units, external disk drive arrays, Redundant Array of Independent Disk (RAID) systems, tape drives, data archival storage systems, etc.

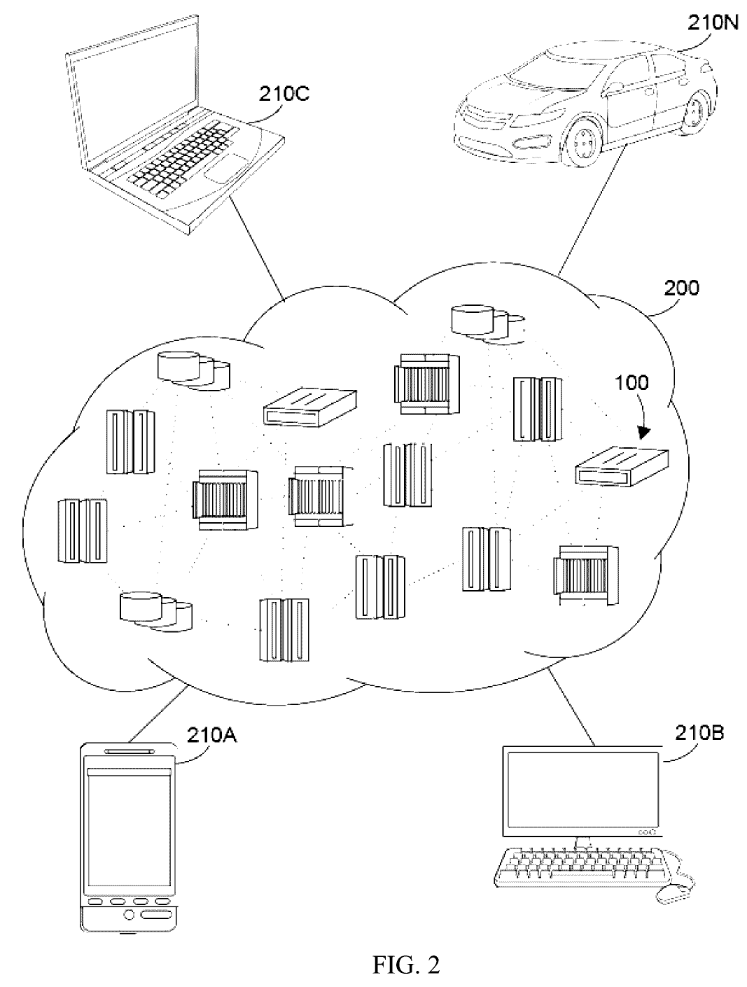

Referring now to FIG. 2, illustrative cloud computing environment 200 is depicted. As shown, cloud computing environment 200 comprises one or more cloud computing nodes 100 with which local computing devices used by cloud consumers, such as, for example, personal digital assistant (PDA) or cellular telephone 210A, desktop computer 210B, laptop computer 210C, and/or automobile computer system 210N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 200 to offer infrastructure, platforms and/or software as services for which a cloud consumer does not need to maintain resources on a local computing device. It is understood that the types of computing devices 210A-N shown in FIG. 2 are intended to be illustrative only and that computing nodes 100 and cloud computing environment 200 can communicate with any type of computerized device over any type of network and/or network addressable connection (e.g., using a web browser).

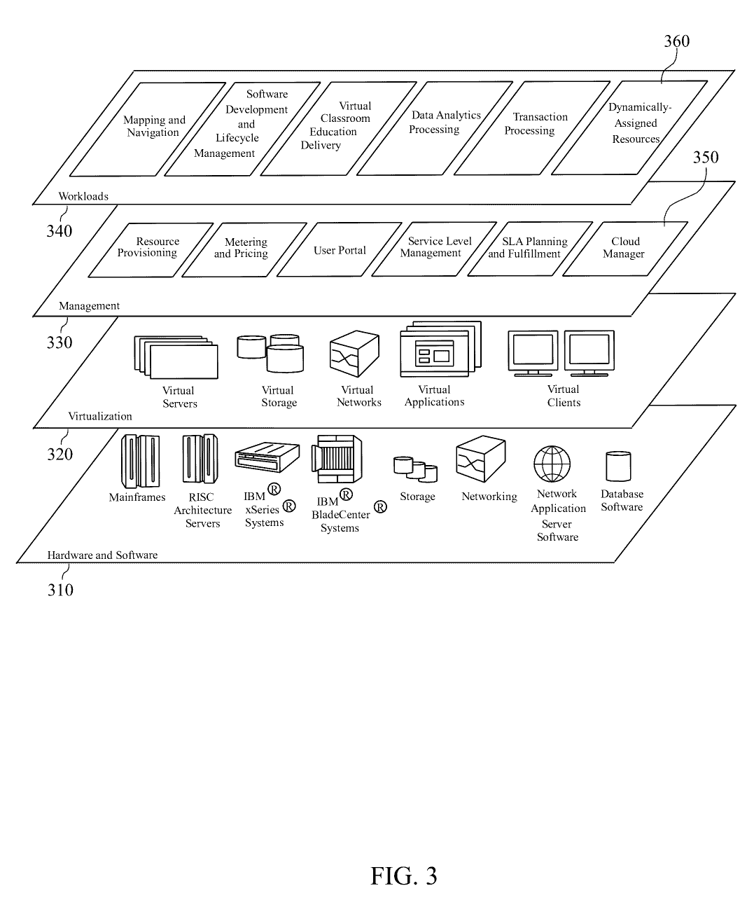

Referring now to FIG. 3, a set of functional abstraction layers provided by cloud computing environment 200 in FIG. 2 is shown. It should be understood in advance that the components, layers, and functions shown in FIG. 3 are intended to be illustrative only and the disclosure and claims are not limited thereto. As depicted, the following layers and corresponding functions are provided.

Hardware and software layer 310 includes hardware and software components. Examples of hardware components include mainframes, in one example IBM System z systems; RISC (Reduced Instruction Set Computer) architecture based servers, in one example IBM System p systems; IBM System x systems; IBM BladeCenter systems; storage devices; networks and networking components. Examples of software components include network application server software, in one example IBM WebSphere® application server software; and database software, in one example IBM DB2® database software. IBM, System z, System p, System x, BladeCenter, WebSphere, and DB2 are trademarks of International Business Machines Corporation registered in many jurisdictions worldwide.

Virtualization layer 320 provides an abstraction layer from which the following examples of virtual entities may be provided: virtual servers; virtual storage; virtual networks, including virtual private networks; virtual applications and operating systems; and virtual clients.

In one example, management layer 330 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A cloud manager 350 is representative of a cloud manager (or shared pool manager) as described in more detail below. While the cloud manager 350 is shown in FIG. 3 to reside in the management layer 330, cloud manager 350 can span all of the levels shown in FIG. 3, as discussed below.

Workloads layer 340 provides examples of functionality for which the cloud computing environment may be utilized. Examples of workloads and functions which may be provided from this layer include: mapping and navigation; software development and lifecycle management; virtual classroom education delivery; data analytics processing; transaction processing; and a set of dynamically-assigned resources 360, which may be used as discussed in more detail below.

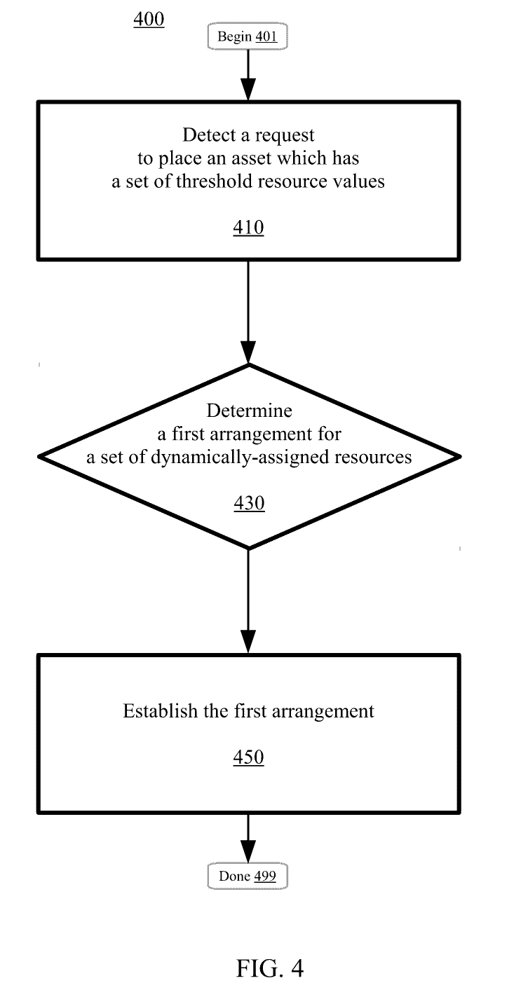

FIG. 4 is a flowchart illustrating a method 400 for managing a shared pool of configurable computing resources according to embodiments. The shared pool of configurable computing resources may use a set of dynamically-assigned resources with respect to capacity-on-demand technology. Also, the shared pool of configurable computing resources may utilize a shared pool manager (e.g., a controller, a cloud manager) to execute/carry-out processes/tasks. The shared pool manager may or may not be included in the shared pool of configurable computing resources.

Capacity-on-demand technology can allow compute servers to have compute resources (e.g., processors, memory) dynamically assigned/activated (to make efficient use of licenses/costs). Capacity-on-demand technology can include built-in hardware resources which can be switched on online and without an interrupt either temporarily or permanently. The set of dynamically-assigned resources (e.g., processors, memory) may be referred to as mobile resources (e.g., non-dedicated resource licenses) which can be allocated to various hosts in response to a triggering event (e.g., as needed/desired/requested). Method 400 may begin at block 401.

At block 410, a request to place an asset which has a set of threshold resource values is detected. Detecting may include, for example, receiving or sensing. The request may be received from a user or a compute node/host. The request can be at least a portion of a data packet (e.g., wrapped message, encrypted transmission). The set of threshold resource values may be included in the request or the asset. The asset can be one or more virtual machines. For example, the set of threshold resource values may indicate a processor or memory capacity sufficient for operation. For instance, 16 cores may be desired/needed to operate a specific virtual machine (e.g., 15 cores would fall short of the threshold and would thereby be insufficient for operation).

At block 430, a first arrangement (e.g., configuration/distribution with respect to a group of compute nodes/hosts) for the set of dynamically-assigned resources is determined. The first arrangement includes a first assignment (e.g., allocation) of at least a portion of the set of dynamically-assigned resources to a first host. The first host uses the first assignment to meet/achieve the set of threshold resource values. For example, a particular arrangement may assign 3 mobile cores to Host-A, 1 mobile core to Host-B, and 0 mobile cores to Host-C. In combination with 13 permanently licensed cores on Host-A, the 3 mobile cores assigned to Host-A may reach the threshold number of cores (e.g., 16) to operate the specific virtual machine on Host-A.

At block 450, the first arrangement is established. Establishing can include allocating or distributing (at least a portion of) the set of dynamically-assigned resources to generate/construct a configuration/mosaic of resources on one or more hosts. In various embodiments, arrangements may be characterized including both mobile and permanent resources, or simply one of mobile or permanent. Arrangements can also include various combinations of resources such as processors or memory. For example, establishing can include selecting hosts for mobile resources and initiating the mobile resources on the hosts to enable processing.

Method 400 concludes at block 499. Aspects of method 400 may provide performance or efficiency benefits for managing a shared pool of configurable computing resources. For example, aspects of method 400 may have positive impacts when using a set of dynamically-assigned resources with respect to capacity-on-demand technology. Altogether, performance or efficiency benefits for utilization of the set of dynamically-assigned resources may occur (e.g., speed, flexibility, responsiveness, availability, resource usage, productivity).

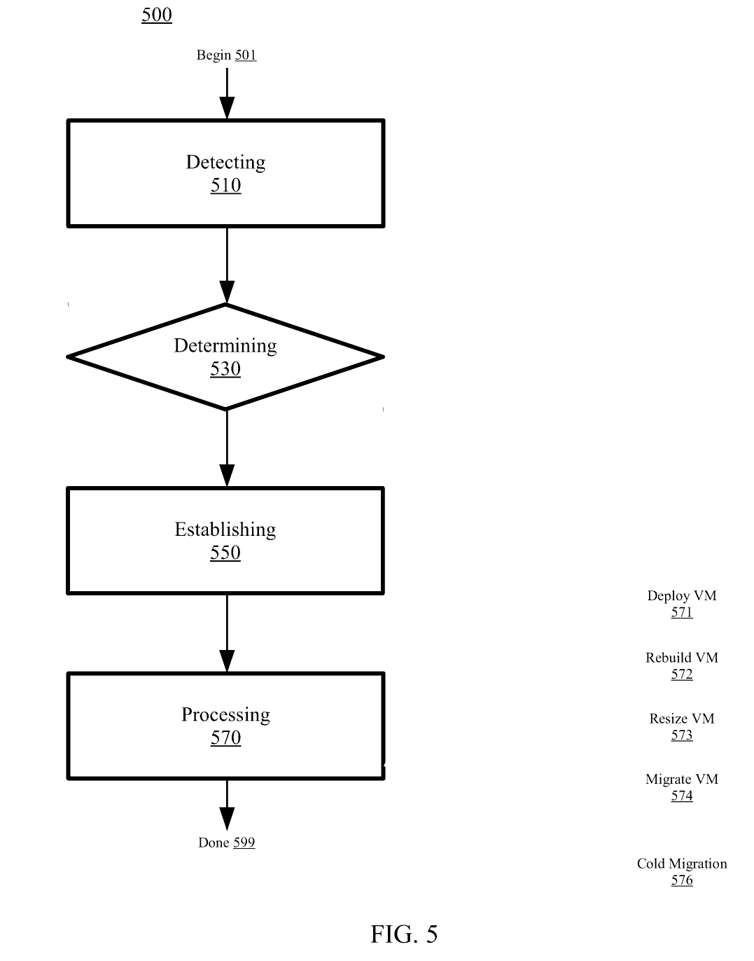

FIG. 5 is a flowchart illustrating a method 500 for managing a shared pool of configurable computing resources according to embodiments. Aspects of method 500 may be similar or the same as aspects of method 400 and aspects may be utilized with other methodologies described herein (e.g., method 600, method 700). Method 500 may begin at block 501. At block 510, a request to place an asset which has a set of threshold resource values is detected. At block 530, a first arrangement for the set of dynamically-assigned resources is determined. The first arrangement includes a first assignment of at least a portion of the set of dynamically-assigned resources to a first host. The first host uses the first assignment to meet the set of threshold resource values. At block 550, the first arrangement is established.

At block 570, the request to place the asset using the first arrangement may be processed. Processing can include carrying-out or executing a task. Placement of an asset (e.g., a virtual machine or the like) can include various operations (e.g., to select an appropriate host). In embodiments, processing the request to place the asset using the first arrangement includes deploying a virtual machine (e.g., to a host such as a new host) at block 571. In embodiments, processing the request to place the asset using the first arrangement includes rebuilding/recovering a virtual machine (e.g., after a host has failed) at block 572. In embodiments, processing the request to place the asset using the first arrangement includes resizing a virtual machine (e.g., changing resource features of a current host) at block 573. In embodiments, processing the request to place the asset using the first arrangement includes migrating a virtual machine (e.g., moving from Host-F to Host-G) at block 574. In certain embodiments, migrating the virtual machine includes a cold migration (e.g., migrating a powered-off/suspended virtual machine) at block 576. Other examples are also considered (e.g., hot/live migration).

Method 500 concludes at block 599. Aspects of method 500 may provide performance or efficiency benefits for managing a shared pool of configurable computing resources. For example, aspects of method 500 may have positive impacts when processing the request to place the asset using the first arrangement. Altogether, performance or efficiency benefits for utilization of the set of dynamically-assigned resources may occur (e.g., speed, flexibility, responsiveness, availability, resource usage, productivity).

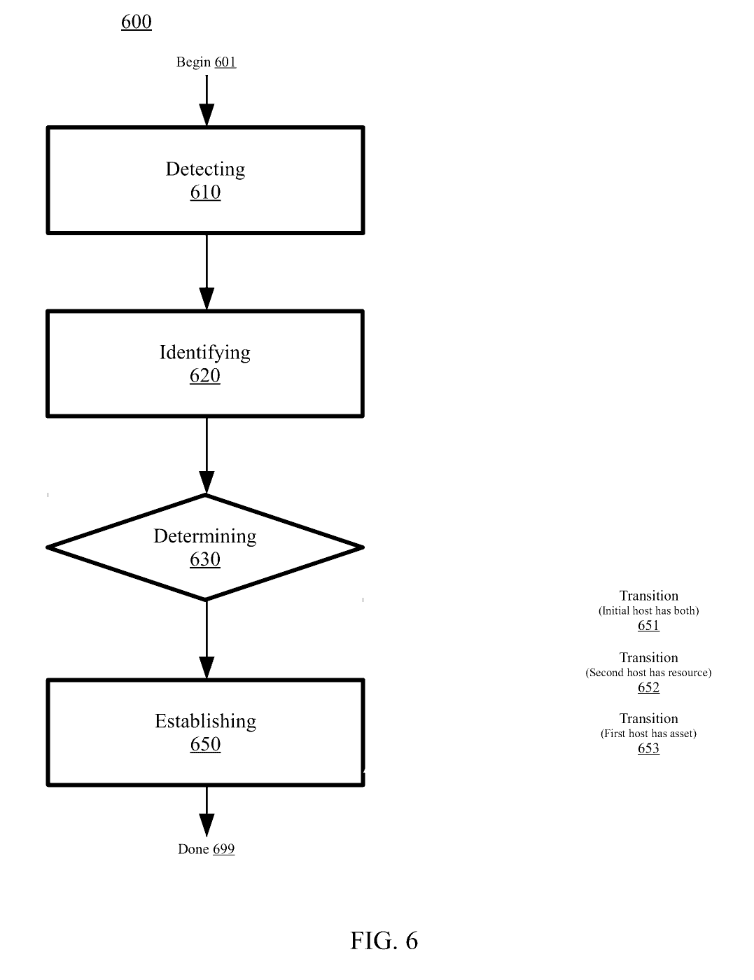

FIG. 6 is a flowchart illustrating a method 600 for managing a shared pool of configurable computing resources according to embodiments. Aspects of method 600 may be similar or the same as aspects of method 400 and aspects may be utilized with other methodologies described herein (e.g., method 500, method 700). Method 600 may begin at block 601. At block 610, a request to place an asset which has a set of threshold resource values is detected.

At block 620, an initial arrangement (e.g., existing/preexisting/expected arrangement) for the set of dynamically-assigned resources may be identified (e.g., ascertained). Such identification may occur in response to detecting the request to place the asset. The initial arrangement may include an initial assignment of the set of dynamically-assigned resources to a set of hosts. Using the initial assignment, the set of threshold resource values may exceed a set of initial resource values of the set of hosts. For example, the set of threshold resource values may be 16 cores and the set of initial resource values may be 0 cores (e.g., host went or is expected to go offline) or 13 cores (e.g., 12 permanent cores and 1 mobile core). Thus, a virtual machine desiring 16 cores may need a new arrangement to operate. As such, a first arrangement may be determined in response to identifying the initial arrangement. At block 630, the first arrangement for the set of dynamically-assigned resources is determined. The first arrangement includes a first assignment of at least a portion of the set of dynamically-assigned resources to a first host. The first host uses the first assignment to meet the set of threshold resource values.

At block 650, the first arrangement is established. In various embodiments, establishing the first arrangement includes transitioning (e.g., assigning/moving) a first dynamically-assigned resource from the set of hosts (e.g., from one or more hosts) to the first host. As such, the first arrangement would be generated with the first dynamically-assigned resource on the first host.

At block 651, the set of hosts can include an initial host which initially has both the first dynamically-assigned resource and an indication of the asset. For example, the initial host may have 13 permanent cores, 3 mobile cores (including the first dynamically-assigned resource), and a virtual machine which uses 16 cores. To take the initial host offline (e.g., for system maintenance), at least one of the mobile cores may be needed/useful for the first host (e.g., if the first host has 15 permanent cores but 0 mobile cores). Accordingly, at least one of the mobile cores from the initial host may be transitioned to the first host. In embodiments, using mobile cores from the initial host may have performance or efficiency benefits with respect to overall system productivity (e.g., allowing other hosts to continue as-is).

At block 652, the set of hosts may include a second host which initially has the first dynamically-assigned resource without an indication of the asset. For example, the second host may have 12 permanent cores, 2 mobile cores (including the first dynamically-assigned resource), and is without a resident virtual machine or the like. The first host may need mobile cores in order to have a virtual machine (e.g., from an initial host) deployed/migrated to it. For instance, the first host may have 15 permanent cores and 0 mobile cores. Virtual machine deployment/migration may require at least 16 total cores. As such, at least one mobile core may be transitioned from the second host. In embodiments, using mobile cores not from the initial host may have performance or efficiency benefits with respect to availability or flexibility (e.g., using unused mobile resources before turning-off the initial host).

At block 653, the first host can initially have an indication of the asset without the first dynamically-assigned resource. For example, the first host may have 15 permanent cores and 0 mobile cores after having lost 3 mobile cores due to a reclamation operation in response to an error event (e.g., the resource manager pulled-back 3 mobile resources which were distributed to the first host in response to a power outage on the first host and subsequently assigned/distributed those 3 mobile resources to other hosts). Initiation of rebuilding a virtual machine on the first host may be underway in order to recover from the error event. As such, the first host may need to be allocated at least one mobile core from the set of hosts (e.g., the second host) in order to successfully recover. In embodiments, the resource manager may distribute at least one mobile core (e.g., at least one it just reclaimed, another one/more that is not in use elsewhere, another one/more that is on a lower priority task elsewhere) to the first host and rebuilding/recovery of the virtual machine may be fully carried-out.

Method 600 concludes at block 699. Aspects of method 600 may provide performance or efficiency benefits for managing a shared pool of configurable computing resources. For example, aspects of method 600 may have positive impacts when identifying an initial arrangement for the set of dynamically-assigned resources or establishing the first arrangement. Altogether, performance or efficiency benefits for utilization of the set of dynamically-assigned resources may occur (e.g., speed, flexibility, responsiveness, availability, resource usage, productivity).

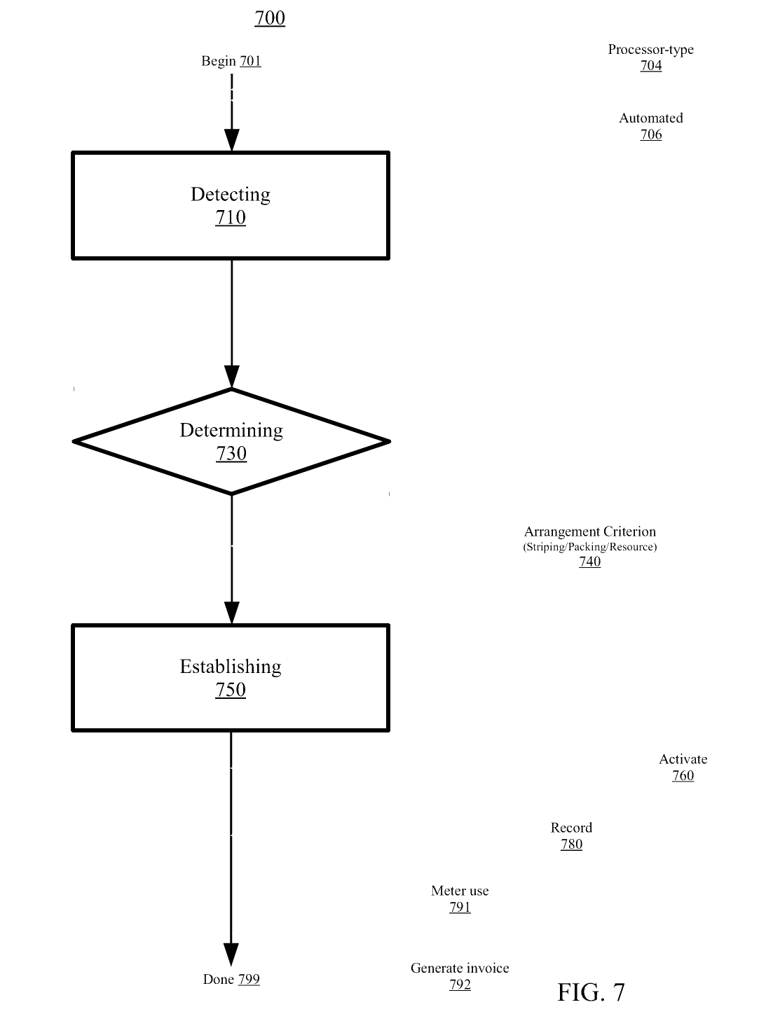

FIG. 7 is a flowchart illustrating a method 700 for managing a shared pool of configurable computing resources according to embodiments. Aspects of method 700 may be similar or the same as aspects of method 400 and aspects may be utilized with other methodologies described herein (e.g., method 500, method 600). Method 700 may begin at block 701.

In embodiments, an x86 processor is absent with respect to the set of dynamically-assigned resources at block 704. x86 processors may utilize software hypervisors for virtualization. x86 processors can have additional layers with respect to non-x86 processors. In certain embodiments, support for a hypervisor is built into the chip (e.g., embedded firmware managing the processor and memory resources). Accordingly, the hypervisor may run as a piece of firmware code interacting with the hardware and virtual machines.

In embodiments, a resource manager may be used at block 706 to manage a set of operations in an automated fashion without user intervention as described herein (e.g., detecting the request, determining the first arrangement, establishing the first arrangement). The resource manager may be included in the shared pool manager, or may be separate. As such, the resource manager can manage capacity-on-demand resources such as the set of dynamically-assigned resources (e.g., mobile/floating processors, mobile/floating memory).

At block 710, a request to place an asset which has a set of threshold resource values is detected. At block 730, the first arrangement for the set of dynamically-assigned resources is determined. The first arrangement includes a first assignment of at least a portion of the set of dynamically-assigned resources to a first host. The first host uses the first assignment to meet the set of threshold resource values.

In various embodiments, the set of dynamically-assigned resources may be determined and arranged/distributed using an arrangement criterion at block 740. The arrangement criterion can include at least one of a striping criterion, a packing criterion, or a resource criterion. Such criteria may be included in an arrangement policy that defines how the mobile resources will be in-real-time/automatically/dynamically-assigned to assets/hosts. The striping criterion can, for example, distribute the resources (relatively) evenly across hosts in the system. The packing criterion may distribute the resources to a first packing host until it reaches its physical capacity, and then move to a second packing host to do the same, and so on. The resource criterion can, for example, distribute the resources to the busiest host (e.g., based on processor/memory utilization during a temporal period), then move on to the next busiest host, and so on. Various combinations for determination and arrangement/distribution of the set of dynamically-assigned resources are considered (e.g., weighting distribution using both the striping and resource criterion).

At block 750, the first arrangement is established. In various embodiments, at least the portion of the set of dynamically-assigned resources is activated (e.g., turned-on, made available for use, a restriction/limitation is removed) on the first host at block 760. Activation may occur without disrupting other resources on other hosts. The activated set of dynamically-assigned resources can receive jobs, workloads, or tasks in response to activation (e.g., before or with priority relative to other resources on other hosts).

In certain embodiments, an indication that the first host includes at least the portion of the set of dynamically-assigned resources is recorded in the set of resource assignment data at block 780 (e.g., coupling in a record a first host identifier and a mobile resource identifier for at least the portion of the set of dynamically-assigned resources). In such embodiments, historical data may be recorded to indicate previous locations of dynamically-assigned resources (e.g., coupling in a historical record an initial host identifier and the mobile resource identifier for at least the portion of the set of dynamically-assigned resources).

In embodiments, a usage assessment may be generated with respect to the capacity-on-demand technology. Use of the set of dynamically-assigned resources may be metered at block 791. For example, mobile processors/memory allocated may be measured based on factors such as quantity allocated, temporal periods of allocation, actual usage, available usage, etc. Such factors may correlate to charge-back or cost burdens which can be defined in-advance (e.g., utilizing usage tiers) or scaled with respect to a market-rate. An invoice or bill presenting the usage, rendered services, fee, and other payment terms may be generated based on the metered use at block 792. The generated invoice may be provided (e.g., displayed in a dialog box, sent or transferred by e-mail, text message, traditional mail) to the user for notification, acknowledgment, or payment.

Method 700 concludes at block 799. Aspects of method 700 may provide performance or efficiency benefits for managing a shared pool of configurable computing resources. For example, aspects of method 700 may have positive impacts when arranging the set of dynamically-assigned resources. Altogether, performance or efficiency benefits for utilization of the set of dynamically-assigned resources may occur (e.g., speed, flexibility, responsiveness, availability, resource usage, productivity).

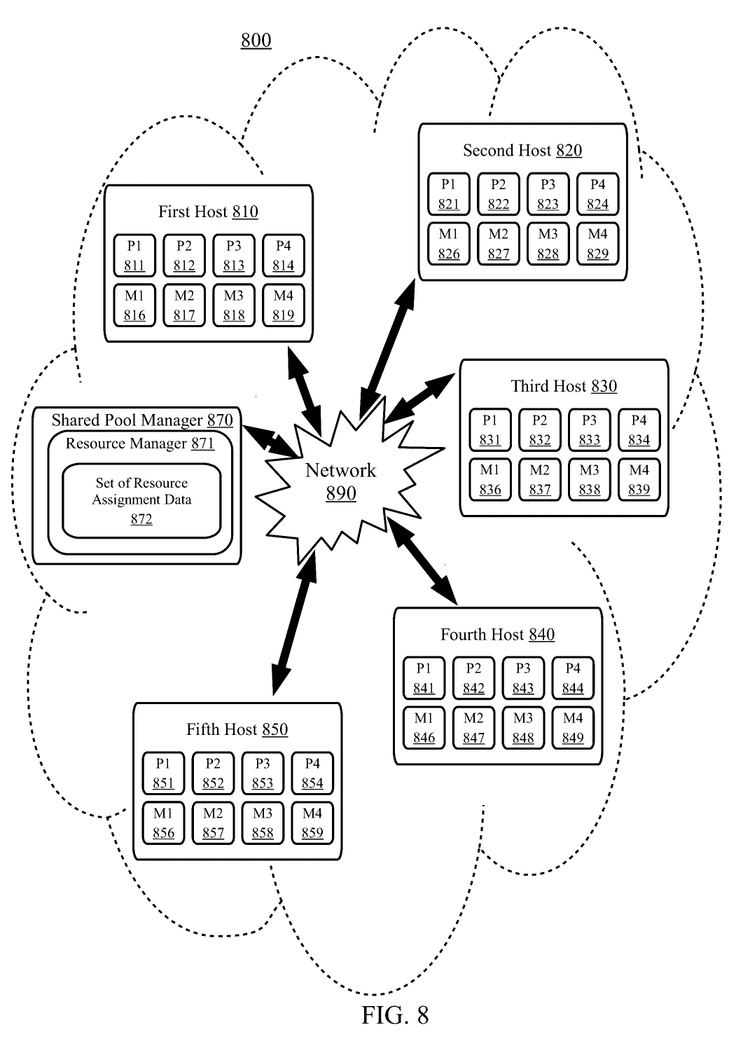

FIG. 8 shows an example system 800 having a shared pool of configurable computing resources which uses a set of dynamically-assigned resources with respect to capacity-on-demand technology according to embodiments. In embodiments, methods 400/500/600/700 may be implemented using aspects described with respect to the example system 800. As such, aspects of the discussion related to FIG. 4/5/6/7 and method 400/500/600/700 may be used or applied in the example system 800. Components depicted in FIG. 8 need not be present, utilized, or located as such in every such similar system, and such components are presented as an illustrative example. Aspects of example system 800 may be implemented in hardware, software or firmware executable on hardware, or a combination thereof. The example system 800 may include the shared pool of configurable computing resources (e.g., the cloud environment). Of course, example system 800 could include many other features or functions known in the art that are not shown in FIG. 8.

A shared pool manager 870 can include a resource manager 871 which has a set of resource assignment data 872. In various embodiments, at least one of the shared pool manager, the resource manager, or the resource assignment data a separate from one another. Such aspects can communicate with a set of hosts via network 890. The first host 810 may include a first set of processors (P1) 811 (e.g., representing 64 processor cores), a second set of processors (P2) 812, a third set of processors (P3) 813, a fourth set of processors (P4) 814, a first set of memory (M1) 816 (e.g., representing 64 memory elements), a second set of memory (M2) 817, a third set of memory (M3) 818, and a fourth set of memory (M4) 819. The second host 820, third host 830, fourth host 840, and fifth host 850 may be configured similarly (e.g., with respect to processors 821, 822, 823, 824, 831, 832, 833, 834, 841, 842, 843, 844, 851, 852, 853, 854 and memory 826, 827, 828, 829, 836, 837, 838, 839, 846, 847, 848, 849, 856, 857, 858, 859).

Capacity-on-demand technology allows hosts to have compute resources (e.g., processors, memory) dynamically activated (e.g., for efficiency of license costs). Consider example system 800 having 256 physical cores per host. However, a user's typical operational load may only generally require 500 of those cores active. As such, the user only licenses the system to run 500 cores which saves licensing fees associated with the remaining 156 cores per host (or 780 in total).

Based on historical information (e.g., past experience), a user may desire to account for peak temporal periods in the user's environment where the user requires additional processor capacity to meet workload demands. However, that extra capacity does not always need to be activated. As such, capacity-on-demand technology may be applied. Mobile cores (e.g., dynamically-assigned processors) may be utilized/purchased. The mobile cores can be dynamically-assigned one or more hosts. For example, the user may implement a group of 320 mobile core licenses. The group can be spread across the user's hosts in a user-defined manner. As such, benefits/savings may result compared to having to permanently license all of these cores (because they are rarely all needed at once). Also, the mobile cores may be assigned according to predetermined or user-defined methodologies (e.g., 0 to the first host, 70 to the second host, 70 to the third host, 80 to the fourth host, and 100 to the fifth host).

Consider the following example. The first host may have 100 permanently licensed cores, 0 mobile cores, and 0 resident virtual machines. The second host may have 100 permanently licensed cores, 70 mobile cores, and 0 resident virtual machines. The third host may have 100 permanently licensed cores, 70 mobile cores, and 0 resident virtual machines. The fourth host may have 100 permanently licensed cores, 80 mobile cores, and 0 resident virtual machines. The fifth host may have 100 permanently licensed cores, 100 mobile cores, and 1 resident virtual machine which is using 200 cores.

An administrator may desire to take the fifth host offline (e.g., for system maintenance). An un-targeted live migration operation (e.g., the cloud scheduler selects a host) is requested (e.g., by an ‘ongoing optimization’ routine, maintenance mode engine, or a user-initiated migration) for the resident virtual machine on the fifth host. Without aspects of the disclosure, the resident virtual machine on the fifth host may not be able to be migrated to another host because there are no hosts with sufficient processor capacity (the resident virtual machine on the fifth host requires 200 cores and no other host has more than 180 cores). Aspects of the disclosure allow for migration of the resident virtual machine to another host using arrangement automation mechanisms described herein. Similar techniques may be utilized with respect to resizing, deploying, etc.

To illustrate, the 100 mobile cores from the fifth host may be collectively reassigned to the first host to allow the migration to succeed. Similarly, a combination of 100 mobile cores from the 320 mobile cores on the second, third, fourth, and fifth hosts may be arranged such that the combination of the 100 mobile cores are on one of the first, second, third, or fourth hosts to allow the migration to succeed. A number of possibilities exist, and varying algorithms may be used in dependence on predefined rules, user inputs, or randomly generated assignments. Processing of resizing/deploying a virtual machine may be similar. For instance, when a resize of a virtual machine cannot be accommodated on the current host, but there are mobile cores/memory available to fit the request, the cores/memory may be transitioned/moved to permit the resize. For virtual machine deployment, if the size of the virtual machine being deployed does not fit on any of the hosts as they initially exist, but if it can be fit by transitioning/moving one or more mobile cores/memory around, a new arrangement may be established to achieve the fit.

Various aspects of the disclosure may be included in example system 800. Aspects may have performance or efficiency benefits relative to x86 systems, relative to live migrating a virtual machine, or relative to technologies which utilize a human/manual interface for arrangement. Consider the illustrative implementation elements and example migration routine which follow.

A resource manager (RM) may manages the mobile resource assignments. A get_available_resources(host) routine can retrieve the number of free/unused permanently licensed resources (e.g., cores, memory) on the host. Such free resources may be available to house additional virtual machines (VMs). A get_mobile_resources_used_by_vm(vm) routine can return the value of min(number of mobile resources that are currently assigned to the VM's source host (vm.source_host), number of resources that are currently assigned to the VM). This may be computed because these resources can be temporarily over-committed and these mobile resources may be reassigned to another host if needed during a mobility operation. When the mobility operation completes, these resources may automatically be removed from the source host and will no longer be over-committed. The number of resources may not be accounted for in get_num_free_mobile_resources(host) as defined herein.

A get_num_unlicensed_resources(host) routine can retrieve the number of unlicensed resources on the host. This number can be the maximum number of (additional) mobile resources that can be assigned to this host. A get_num_free_mobile_resources(host) routine can retrieve the number of free (e.g., available to be reassigned to another host) mobile resources from the host. Free can include that the resource is not required for use by any virtual machine on the system (e.g., essentially the return value of min(num_mobile_resource_assigned_to_host, host_activated_resource_capacity−total_resources_required_by_resident_VMs)). For example, in the context of the fifth host in the above example, this would return 0 since all mobile cores are needed to house the resident virtual machine; in the context of the fourth host in the above example, this would return 80 because it is not needed by a virtual machine.

A get_num_free_mobile_resources_in_cloud(set_of_hosts) routine can retrieve the summation of get_num_free_mobile_resources(h) for each host h in set_of_hosts and the free resources (not assigned to any host) in the pool (i.e., a cloud level perspective of the total free mobile resources). That is, total:=free_resources_in_enterprise_pool (i.e., unassigned pool resources, if any) for host h in set_of_hosts total:=total+get_num_free_mobile_resources(h) return total. A assign_mobile_resources_from_pool(target) routine may assign the available mobile resources (not assigned to any host) in the pool to the ‘target’ host by way of the RM. A reassign_mobile_resources(source, target, vm) routine can reassign the available mobile resources from the source_host to the ‘target’ host by way of the RM. (The VM may be passed in as well for this routine because if the VM's source_host happens to also be the ‘source’, then resources that the VM is currently using based on the RM's over-commitment strategy may be reassigned).

A sort_candidate_hosts(set_of_hosts) routine can perform an “in place” sort of a set of hosts based on a placement policy. Examples of such a policy include: striping by ordering the hosts based on the number of VMs currently running on the host (e.g., in ascending order), packing by ordering the hosts based on the number of VMs currently running on the host (e.g., in descending order), memory allocation based by ordering the hosts based on the amount of host memory allocated (e.g., in ascending order), or processor utilization based by ordering the hosts based on the current percentage of processor utilization over a period of time (e.g., in ascending order). A get_viable_hosts(vm, operation_type) routine may return a list of viable candidate hosts to house the virtual machine (operation_type=deploy|live_migration|cold_migration|etc.).

```
        candidate_hosts := empty list
# Determine how many mobile resources can be used
free_mobile_resources := get_num_free_mobile_resources_in_cloud
(set_of_all_hosts_in_cloud)
if operation_type == live_migration or operation_type == cold_migration:
  # can reassign the mobile resources used by the VM ...
    free_mobile_resources := free_mobile_resources +
    get_mobile_resources_used_by_vm(vm)
        for each host h in the cloud:
    # Ask if there are enough free resources for this host to house the VM
      if get_available_resources(host) + free_mobile_resources >=
      vm.required_resource:
      # Ask if there are enough unlicensed resources on this host to accommodate
      the number of
mobile resources that must be assigned to this host so that it can house the VM?
      if get_available_resources(host) + get_num_free_mobile_resources(host) +
get_num_unlicensed_resources(host) >= vm.required_resource:
      # Aspects described herein can show placement options by way of (re)assignment
      of mobile
resources.
            candidate_hosts.append(h)
          if operation_type == live_migration or operation_type == cold_migration:
        # so as to not self-migrate
        candidate_hosts = candidate_hosts - {vm.source_host}
    return candidate_hosts
          migrate(vm):
    candidate_hosts := get_viable_hosts(vm, live_migration)
    if candidate_hosts is empty:
      raise NoValidHost error
          sort_candidate_hosts(candidate_hosts)
    target_host := candidate_hosts[0]
          # Assign available mobile resources in the pool
    if (get_available_resources(target host) + get_num_free_mobile_resources
        (target_host) <
vm.required_resource):
        assign_mobile_resources_from_pool(target_host)
            # reassign mobile resources from hosts to facilitate mobility
      while (get_available_resources(target_host) +
get_num_free_mobile_resources(target_host) < vm.required_resource):
            # reassign mobile resources
            for host in h in cloud [such that h is NOT the target host]:
                reassign_mobile_resources(h, target_host, vm)
              # target_host has sufficient resources and the migration can
              be performed
          perform_migration(vm, source_host, target_host)
```

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

1. A computer-implemented method for managing a shared pool of configurable computing resources, the method comprising:
detecting, by the shared pool of configurable computing resources, a request to place an asset which has a set of threshold resource values;
determining a first arrangement for a set of dynamically-assigned resources, wherein the first arrangement includes a first assignment of at least a portion of the set of dynamically-assigned resources to a first host, and wherein the first host uses the first assignment to meet the set of threshold resource values; and
establishing, by the shared pool of configurable computing resources, the first arrangement.

2. The method of claim 1, further comprising:
processing the request to place the asset using the first arrangement.

3. The method of claim 2, wherein processing the request to place the asset using the first arrangement includes deploying a virtual machine.

4. The method of claim 2, wherein processing the request to place the asset using the first arrangement includes rebuilding a virtual machine.

5. The method of claim 2, wherein processing the request to place the asset using the first arrangement includes resizing a virtual machine.

6. The method of claim 2, wherein processing the request to place the asset using the first arrangement includes migrating a virtual machine.

7. The method of claim 6, wherein migrating the virtual machine includes a cold migration.

8. The method of claim 1, further comprising:
identifying, in response to detecting the request to place the asset, an initial arrangement for the set of dynamically-assigned resources, wherein the initial arrangement includes an initial assignment of the set of dynamically-assigned resources to a set of hosts, and wherein the set of threshold resource values exceeds a set of initial resource values of the set of hosts using the initial assignment; and
determining the first arrangement in response to identifying the initial arrangement.

9. The method of claim 8, wherein establishing the first arrangement includes:
transitioning a first dynamically-assigned resource from the set of hosts to the first host, wherein the set of hosts includes an initial host which initially has both the first dynamically-assigned resource and an indication of the asset.

10. The method of claim 8, wherein establishing the first arrangement includes:
transitioning a first dynamically-assigned resource from the set of hosts to the first host, wherein the set of hosts includes a second host which initially has the first dynamically-assigned resource without an indication of the asset.

11. The method of claim 8, wherein establishing the first arrangement includes:
transitioning a first dynamically-assigned resource from the set of hosts to the first host, wherein the first host initially has an indication of the asset without the first dynamically-assigned resource.

12. The method of claim 1, further comprising:
determining to arrange the set of dynamically-assigned resources using a criterion, wherein the criterion includes a selection from a group consisting of at least one of a striping criterion, a packing criterion, or a resource criterion; and
arranging the set of dynamically-assigned resources using the criterion.

13. The method of claim 1, wherein an x86 processor is absent with respect to the set of dynamically-assigned resources.

14. The method of claim 1, wherein detecting the request, determining the first arrangement, and establishing the first arrangement each occur in an automated fashion without user intervention utilizing a computer hardware processor.

15. The method of claim 1, further comprising activating at least the portion of set of dynamically-assigned resources on the first host.

16. The method of claim 1, further comprising recording, in a set of resource assignment data, an indication that the first host includes at least the portion of the set of dynamically-assigned resources.

17. The method of claim 1, further comprising:
metering use of the set of dynamically-assigned resources; and
generating an invoice based on the metered use.

18-20. (canceled)
